(19) United States
(12) Patent Application Publication
(10) Pub. No.: US 2018/0087661 A1
(43) Pub. Date: Mar. 29, 2018

(54) MULTI-PRESSURE HYDRAULIC CONTROL SYSTEM FOR A STEP-GEAR AUTOMATIC TRANSMISSION

(71) Applicant: BorgWarner Inc., Auburn Hills, MI (US)

(72) Inventors: Chengyun GUO, Novi, MI (US); Christopher A. Spangler, Rochester Hills, MI (US); Dmitriy SEMENOV, Rochester Hills, MI (US)

(21) Appl. No.: 15/566,839

(22) PCT Filed: Apr. 12, 2016
(86) PCT No.: PCT/US2016/027012

§ 371 Date: Oct. 16, 2017

Related U.S. Application Data
(60) Provisional application No. 62/148,805, filed on Apr. 17, 2015.

(51) Int. Cl. F16H 61/00; F16H 61/4061; F16H 61/431; B60K 17/10

(52) U.S. Cl. CPC F16H 61/0021; F16H 61/4061; B60K 17/02; B60K 17/10; F16H 61/431

(57) ABSTRACT

A multi-pressure hydraulic control system (66) for use with a step-gear automatic transmission (14) of a vehicle powertrain system (10) includes at least one pump (28) having a rotatable pump member (34), at least one inlet region (40) for receiving fluid to be pumped by the pump member (34), and at least one outlet region (42) for outputting fluid pumped by the pump member (34), and a switching valve (78) receiving at least three separate outputs of fluid pumped by the at least one pump (28) for allowing the at least three separate outputs to be selectively combined and/or separated, the switching valve (78) having a valve member (79) being movable between at least three positions that produces fluid outputs having a high fluid pressure, a medium fluid pressure, and a low fluid pressure to one or more portions of the stepgear automatic transmission (14).

### CROSS-REFERENCE TO RELATED APPLICATION(S)

The present application claims priority to and all the benefits of U.S. Provisional Patent Application No. 62/148,805, filed on Apr. 17, 2015, which is hereby expressly incorporated herein by reference in its entirety.

### BACKGROUND OF INVENTION

### 1. Field of Invention

The present invention relates generally to powertrain systems and, more specifically, to a multi-pressure hydraulic control system for a step-gear automatic transmission.

### 2. Description of the Related Art

Conventional vehicle powertrain systems known in the art typically include an engine in rotational communication with a transmission. The engine generates rotational torque which is selectively translated to the transmission which, in turn, translates rotational torque to one or more wheels. The transmission multiplies the rotational speed and torque generated by the engine through a series of predetermined gear sets, whereby changing between the gear sets enables a vehicle to travel at different vehicle speeds for a given engine speed. Thus, the gear sets of the transmission are configured such that the engine can operate at particularly desirable rotational speeds so as to optimize performance and efficiency.

In addition to changing between the gear sets, the transmission is also used to modulate engagement with the engine, whereby the transmission can selectively control engagement with the engine so as to facilitate vehicle operation. By way of example, torque translation between the engine and the transmission is typically interrupted while the vehicle is parked or idling, or when the transmission changes between the gear sets. In some automatic transmissions, modulation is achieved via a hydrodynamic device such as a hydraulic torque converter. In some automatic transmissions, the torque converter is removed and replaced with a single starting clutch. Automatic transmissions are typically controlled using hydraulic fluid, and include a pump assembly, one or more solenoid valves, and an electronic controller. The pump assembly provides a source of fluid power to the solenoid valves which, in turn, are actuated by the controller so as to selectively direct hydraulic fluid throughout the automatic transmission to control modulation of rotational torque generated by the engine. The solenoid valves are also typically used to change between the gear sets of the automatic transmission, and may also be used to control hydraulic fluid used to cool and/or lubricate various components of the automatic transmission in operation.

Depending on the specific configuration of the automatic transmission, clutch modulation and/or gear actuation may necessitate operating the pump assembly so as to pressurize the hydraulic fluid at relatively high magnitudes. Conversely, lubrication and/or cooling typically require significantly lower hydraulic fluid pressure, whereby excessive pressure has a detrimental effect on transmission operation and/or efficiency. Moreover, hydraulic fluid heats up during operation of the automatic transmission, and changes in the temperature of the hydraulic fluid result in a corresponding change in the viscosity of the hydraulic fluid. As such, where specific hydraulic pressure is needed to properly operate the automatic transmission, the volume of hydraulic fluid required to achieve the requisite hydraulic pressure varies with operating temperature. Further, where the pump assembly is driven by the powertrain system, fluid flow is proportional to pump rotational speed. Because fluid flow increases with increased rotational speed, under certain operating conditions, a significant volume of fluid displaced by the pump assembly must be re-circulated to maintain proper fluid flow and pressure requirements throughout the automatic transmission, thereby leading to disadvantageous parasitic loss which results in low efficiency.

Each of the components and systems of the type described above must cooperate to effectively modulate translation of rotational torque from the engine to the wheels of the vehicle. In addition, each of the components and systems must be designed not only to facilitate improved performance and efficiency, but also so as to reduce the cost and complexity of manufacturing the vehicles.

The efficiency of the hydraulic control system for an automatic transmission can be improved through the usage of one or more pumps with multiple output ports that feed different portions of the hydraulic control system with fluid that is at different pressure levels and different flow rates. Thus, there is a need in the art to provide a new hydraulic control system for usage with a step-gear automatic transmission that achieves this efficiency.

### SUMMARY OF THE INVENTION

The present invention provides a multi-pressure hydraulic control system for use with a step-gear automatic transmission of a vehicle powertrain system including at least one pump having a rotatable pump member, at least one inlet region for receiving fluid to be pumped by the pump member, and at least one outlet region for outputting fluid pumped by the pump member. The multi-pressure hydraulic control system also includes a switching valve receiving at least three separate outputs of fluid pumped by the at least one pump for allowing the at least three separate outputs to be selectively combined and/or separated, the switching valve having a valve member being movable between at least three positions that produces fluid outputs having a high fluid pressure, a medium fluid pressure, and a low fluid pressure to one or more portions of the step-gear automatic transmission.

In addition, the present invention provides a method for controlling a multi-pressure hydraulic control system for use with a step-gear automatic transmission of a vehicle powertrain system including the steps of pumping fluid by at least one pump including a rotatable pump member, at least one inlet region for receiving fluid to be pumped by the pump member, and at least one outlet region for outputting fluid pumped by the pump member. The method also includes the steps of receiving at a switching valve at least three outputs of fluid pumped by the at least one pump, the switching valve having a valve member being movable between at least three positions, and moving the valve member between the at least three positions to produce fluid outputs having a high fluid pressure, a medium fluid pressure, and a low fluid pressure to one or more portions of the step-gear automatic transmission.

One advantage of the present invention is that a new multi-pressure hydraulic control system is provided for a step-gear automatic transmission. Another advantage of the present invention is that the multi-pressure hydraulic control system includes one or more pumps with multiple output ports that feed different portions of the hydraulic control system with fluid that is at different pressure levels and different flow rates. Yet another advantage of the present invention is that the multi-pressure hydraulic control system includes a switching valve that allows the multiple outputs of the one or more pumps to be selectively combined to meet the highest flow demand portion of the system.

### BRIEF DESCRIPTION OF THE DRAWINGS

Other objects, features, and advantages of the present invention will be readily appreciated as the same becomes better understood after reading the subsequent description taken in connection with the accompanying drawings wherein:

FIG. 1 is a schematic view of a vehicle powertrain system including a step-gear automatic transmission and a multi-pressure hydraulic control system, according to the present invention; and

FIG. 2 is a schematic view of one embodiment of the multi-pressure hydraulic control system, according to the present invention, for use with the step-gear automatic transmission of FIG. 1.

### DETAILED DESCRIPTION OF THE INVENTION

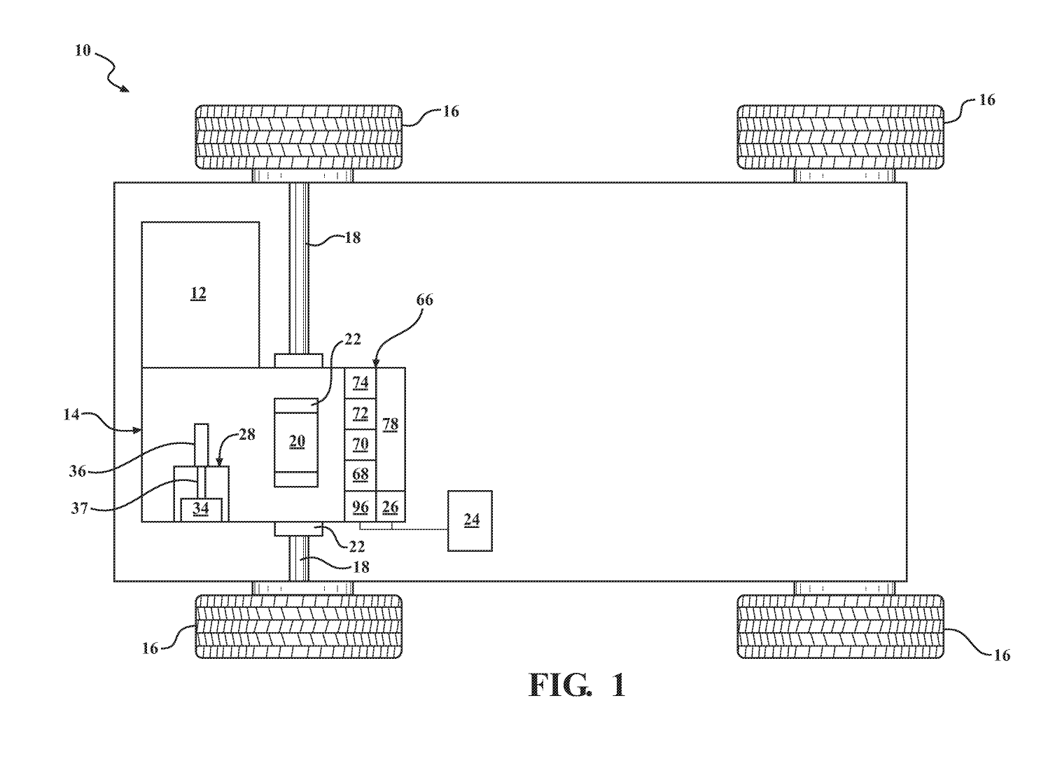

Referring now to the figures, where like numerals are used to designate like structure unless otherwise indicated, a vehicle powertrain system is schematically illustrated at 10 in FIG. 1. The powertrain system 10 includes an engine 12 in rotational communication with a step-gear automatic transmission 14. The engine 12 generates rotational torque which is selectively translated to the step-gear automatic transmission 14 which, in turn, translates rotational torque to one or more wheels, generally indicated at 16. To that end, a pair of continuously-variable joints 18 translates rotational torque from the step-gear automatic transmission 14 to the wheels 16. It should be appreciated that the engine 12 and the step-gear automatic transmission 14 of FIG. 1 are of the type employed in a conventional “transverse front wheel drive” powertrain system 10. It should also be appreciated that the engine 12 and/or step-gear automatic transmission 14 could be configured in any suitable way sufficient to generate and translate rotational torque so as to drive the vehicle, without departing from the scope of the present invention.

The step-gear automatic transmission 14 multiplies the rotational speed and torque generated by the engine 12 through a series of predetermined gear sets 20 (not shown in detail, but generally known in the art), whereby changing between the gear sets 20 enables the vehicle to travel at different vehicle speeds for a given speed of the engine 12. Thus, the gear sets 20 of the step-gear automatic transmission 14 are configured such that the engine 12 can operate at particularly desirable rotational speeds so as to optimize vehicle performance and efficiency. In addition to changing between the gear sets 20, the step-gear automatic transmission 14 is also used to modulate engagement with the engine 12, whereby the transmission 14 can selectively control engagement with the engine 12 so as to facilitate vehicle operation. By way of example, torque translation between the engine 12 and the step-gear automatic transmission 14 is typically interrupted while the vehicle is parked or idling, or when the transmission 14 changes between the gear sets 20. In conventional automatic transmissions, modulation of rational torque between the engine 12 and the step-gear automatic transmission 14 is achieved via a hydrodynamic device, such as a hydraulic torque converter (not shown, but generally known in the art). An example of the step-gear automatic transmission 14 is disclosed in U.S. Pat. No. 6,830,531 to Koenig et al., the disclosure of which is hereby incorporated by reference in its entirety. It should be appreciated that the step-gear automatic transmission 14 is adapted for use with vehicles such as automotive vehicles, but could be used in connection with any suitable type of vehicle.

Irrespective of the specific configuration of the powertrain system 10, the step-gear automatic transmission 14 is typically controlled using hydraulic fluid. Specifically, the step-gear automatic transmission 14 is cooled, lubricated, actuated, and modulates torque using hydraulic fluid. To these ends, the step-gear automatic transmission 14 typically includes a controller 24 in electrical communication with one or more solenoids 26 (see FIG. 1) used to direct, control, or otherwise regulate flow of fluid throughout the transmission 14, as described in greater detail below. In order to facilitate the flow of hydraulic fluid throughout the step-gear automatic transmission 14, the powertrain system 10 includes at least one or more pumps, generally indicated at 28. In one embodiment, the pump 28 may be a positive displacement pump assembly as disclosed in DKT14308A, the disclosure of which is hereby incorporated by reference in it entirety. It should be appreciated that either a three-output pump 28, three independent pumps 28, or three coaxially driven pumps 28, or any combination of pumps 28 that provides three separate output ports may be used.

The pump 28 is adapted to provide a source of fluid power to the powertrain system 10. Specifically, the pump 28 provides fluid power to various locations and components of the step-gear automatic transmission 14, as described in greater detail below. While the pump 28 is described herein as providing fluid power to the step-gear automatic transmission 14 of the powertrain system 10, those having ordinary skill in the art will appreciate that the pump 28 could be used in connection with any suitable part of the powertrain system 10 without departing from the scope of the present invention. By way of non-limiting example, the pump 28 of the present invention could be used to direct or otherwise provide a source of fluid power to the engine 12, a transfer case (not shown, but generally known in the art), or any other powertrain component that utilizes fluid for lubrication, cooling, control, actuation, and/or modulation.

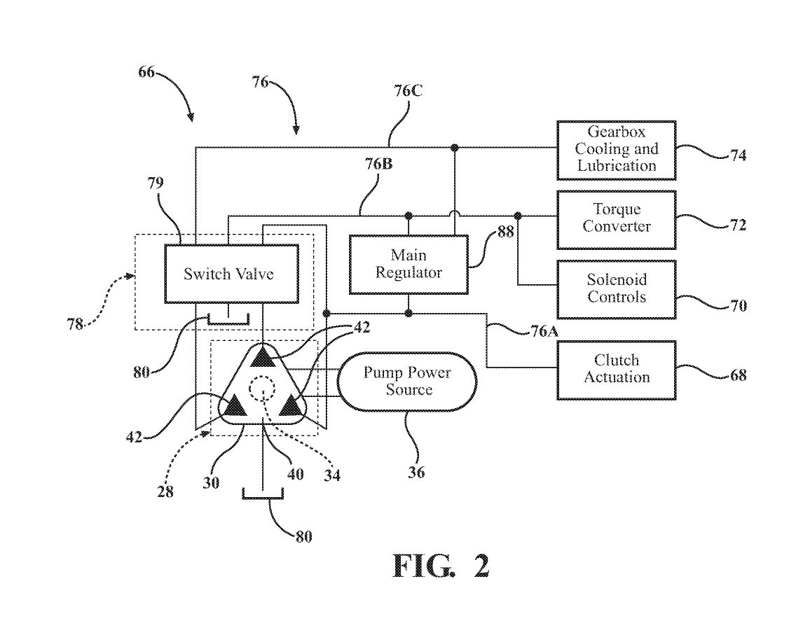

In one embodiment, the pump 28 includes a stator 30 having a chamber and a rotatable pump member 34 disposed in the chamber of the stator 30 (FIG. 2). The pump member 34 is disposed in torque translating relationship with the powertrain system 10. More specifically, the pump member 34 receives rotational torque from a prime mover 36 (not shown in detail, but generally known in the art) of the powertrain system 10. In the representative embodiment illustrated herein, the pump member 34 is coupled to an input shaft 37 which, in turn, is disposed in rotational communication with the prime mover 36. However, those having ordinary skill in the art will appreciate that the pump 28 could be configured differently, with or without the use of an input shaft 37, without departing from the scope of the present invention. Moreover, it should be appreciated that the pump member 34 could receive rotational torque from the powertrain system 10 in a number of different ways. By way of non-limiting example, the pump member 34 could be directly coupled to the prime mover 36, or one or more geartrains (not shown in detail, but generally known in the art) could be interposed between the pump member 34 and the prime mover 36 so as to adjust the rotational speed and torque therebetween.

In the representative embodiment illustrated herein, the pump 28 is disposed in rotational communication with the prime mover 36 that is supported in the step-gear automatic transmission 14. However, those having ordinary skill in the art will appreciate that the prime mover 36 could be realized by any suitable component of the powertrain system 10 without departing from the scope of the present invention. By way of non-limiting example, the prime mover 36 could be realized by a shaft supported in rotational communication with the engine 12 and/or the step-gear automatic transmission 14, or the prime mover 36 could be a shaft of an electric motor (not shown, but generally known in the art).

As noted above, each pump 28 includes at least one inlet region or port 40 for receiving fluid to be pumped by the pump member 34 and at least one outlet region or port 42 for outputting fluid pumped by the pump member 34. In one embodiment illustrated in FIG. 2, a single pump 28 has one inlet region 40 and three outlet regions 42. Rotation of the pump member 34 within the chamber displaces fluid such that each of the outlet regions 42 provides a respective and separate source of fluid power to the powertrain system 10. It should be appreciated that the pump 28 can be configured in a number of different ways.

As noted above, the present invention is directed toward a multi-pressure hydraulic control system, according to the present invention and generally indicated at 66, for use with the step-gear automatic transmission 14. The multi-pressure control system 66 directs or otherwise controls fluid power from the outlet regions 42 of the pump 28 to the powertrain system 10, as described in greater detail below. It will be appreciated that the multi-pressure hydraulic control system 66 can be configured in a number of different ways to direct fluid to the step-gear automatic transmission 14.

Referring now to FIG. 2, an exemplary embodiment of the multi-pressure hydraulic control system 66 and pump 28 is shown in connection with the step-gear automatic transmission 14. As noted above, the step-gear automatic transmission system 14 utilizes hydraulic fluid for lubrication, actuation, modulation, and/or control. To that end, the step-gear automatic transmission 14 includes a clutch actuation portion or circuit 68, a solenoid controls portion or circuit 70, a torque converter portion or circuit 72, and a gearbox cooling and lubrication portion or circuit 74. The clutch actuation circuit 68 is used to selectively actuate the clutch assemblies 22 so as to modulate rotational torque between the engine 12 and the step-gear automatic transmission 14. The solenoid controls circuit 70 is used to selectively switch between solenoid valves 26 of the step-gear automatic transmission 14. The torque converter circuit 72 is used to control flow of hydraulic fluid to the torque converter of the step-gear automatic transmission 14. Similarly, the gearbox cooling and lubrication circuit 74 is used to control flow of hydraulic fluid to the gearbox and/or other locations throughout the step-gear automatic transmission 14, such as shafts, bearings, gears, and the like (not shown in detail, but generally known in the art), for cooling and/or lubrication. Those having ordinary skill in the art will appreciate that there are a number of different ways that the circuits 68, 70, 72, 74 described above could be configured. As such, each of the circuits 68, 70, 72, 74 is depicted generically. Moreover, it will be appreciated that the multi-pressure hydraulic control system 66 could be used to direct fluid power to any suitable number of circuits, configured in any suitable way and for any suitable purpose of the powertrain system 10, without departing from the scope of the present invention. Similarly, while the representative embodiment illustrated herein describes the multi-pressure hydraulic control system 66 as used with hydraulic fluid in the step-gear automatic transmission 14, those having ordinary skill in the art will appreciate that the multi-pressure hydraulic control system 66 and pump 28 can be adapted to displace or otherwise direct any suitable type of fluid to any suitable component or system of the powertrain system 10 of any suitable type or configuration without departing from the scope of the present invention.

Those having ordinary skill in the art will appreciate that each of the circuits 68, 70, 72, 74 may require respectively different pressure and/or flow requirements. In one embodiment, the multi-pressure hydraulic control system 66 requires three different pressure levels. By way of non-limiting example, in the representative embodiment of the multi-pressure hydraulic control system 66 described herein, the clutch actuation circuit 68 requires a relatively high or first hydraulic fluid pressure (for example, ˜15-20 bar) for applying and holding the clutch assemblies 22. This pressure depends on the clutch gain and transmission torque. The clutch solenoid controls circuit 70 and the torque converter circuit 72 require a medium or second hydraulic fluid pressure (for example, ˜2 bar) for controlling the solenoids 26 and for feeding the torque converter. The gearbox cooling and lubrication circuit 74 requires a low or third hydraulic fluid pressure (for example, <0.5 bar) for cooling and lubricating the gearbox. It should be appreciated that this portion of the system requires a flow rate dependent on the speed, torque, and temperature that the step-gear automatic transmission 14 is operating at.

To facilitate the competing flow and pressure requirements of the circuits 68, 70, 72, 74, the multi-pressure hydraulic control system 66 includes a plurality of fluid lines, generally indicated at 76, and a switching valve, generally indicated at 78, that cooperate with the pump 28. In the representative embodiment illustrated herein, one fluid line 76A of the fluid lines 76, also known as a main line, is disposed in fluid communication with one outlet region 42 of the pump 28, the switching valve 78, and the clutch actuation circuit 68. The clutch actuation circuit 68 has the high hydraulic fluid pressure requirements of the step-gear automatic transmission 14. Another fluid line 76B of the fluid lines 76 is disposed in fluid communication with the switching valve 78 and the solenoid controls circuit 70 and the torque converter circuit 72. The solenoid controls circuit 70 and the torque converter circuit 72 have the medium hydraulic fluid pressure requirements of the step-gear automatic transmission 14. Yet another fluid line 76C of the fluid lines 76 is disposed in fluid communication with the switching valve 78 and the gearbox cooling and lubrication circuit 74. The gearbox cooling and lubrication circuit 74 has the low hydraulic fluid pressure requirements of the step-gear automatic transmission 14. It should be appreciated that the fluid lines 76 could be defined in any suitable way, disposed in fluid communication with any suitable component or circuit of the multi-pressure hydraulic control system 66, without departing from the scope of the present invention.

The switching valve 78 includes a movable valve member 79 having a first position, a second position, and a third position that allows for two or three of the output regions 42 of the pump 28 to be selectively combined or separated, routed into different circuits or returned to a pump suction (not shown) to minimize hydraulic power losses of the pump 28. In this embodiment, when the valve member 79 of the switching valve 78 is in the first position, fluid power from one of the outlet regions 42 is directed to the fluid line 76A and fluid power from the other two outlet regions 42 is directed away from the fluid line 76A to provide the low or third hydraulic fluid pressure. When the switching valve 78 is in the second position, fluid power from two of the outlet regions 42 is directed to the fluid line 76A and fluid power from the other outlet region 42 is directed away from the fluid line 76A to provide the medium or second hydraulic fluid pressure. When the switching valve 78 is in the third position, fluid power from all three of the outlet regions 42 is directed to the fluid line 76A to provide the high or first hydraulic fluid pressure. The valve member 79 of the switching valve 78 is selectively moveable between the positions so as to control flow of fluid power from the outlet regions 42 of the pump 28 to the fluid line 76A. In one embodiment, the switching valve 78 is a directional valve as disclosed in DKT15046, the disclosure of which is hereby incorporated by reference in its entirety. It should be appreciated that the switching valve 78 may be used to direct some of the flow back to the inlet region(s) 40 of the pump 28 to bypass all actuation circuits. It should be appreciated that the switching valve 78 has the ability to selectively control the three outputs of the pump 28 to meet the flow and pressure demands of all portions of the multi-pressure hydraulic control system 66 while also minimizing wasted energy.

As will be appreciated from the subsequent description below, the positions of the switching valve 78 described above enable the pump 28 to combine fluid power from the three outlet regions 42 in predetermined ways so as to ensure proper hydraulic fluid pressure at the fluid line 76A under different operating conditions of the step-gear automatic transmission 14. In the exemplary embodiment of the positions described above and illustrated in FIG. 2, the multi-pressure hydraulic control system 66 directs fluid power from all three outlet regions 42 to the fluid line 76A when the valve member 79 of the switching valve 78 is in the third position. It should be appreciated that the step-gear automatic transmission 14 and/or multi-pressure hydraulic control system 66 could have significantly different operating requirements, depending on the application. It should also be appreciated that the switching valve 78 could be configured with any suitable number of positions adapted to direct fluid from the pump 28 in a number of different ways, without departing from the scope of the present invention.

In one embodiment, the multi-pressure hydraulic control system 66 includes a sump 80 for providing a source of hydraulic fluid to the inlet region(s) 40 of the pump 28. More specifically, the sump 80 is adapted to store non-pressurized hydraulic fluid and is disposed in fluid communication with all inlet region(s) 40 of the pump 28. However, while the multi-pressure hydraulic control system 66 depicted herein utilizes a common sump 80 for all inlet regions 40, it should be appreciated that a plurality of sumps 80 could be utilized. By way of non-limiting example, each inlet region 40 could be disposed in fluid communication with a different sump (not shown, but generally known in the art). In one embodiment, when the valve member 79 of the switching valve 78 is in the first position and/or the second position, fluid power directed away from the fluid line 76A is at least partially directed to the sump 80. Similarly, when the switching valve 78 is in the first position and/or the second position, fluid power directed away from the fluid line 76A is at least partially directed to the gearbox cooling and lubrication circuit 74.

In one embodiment, the multi-pressure hydraulic control system 66 includes a pressure regulator valve 88 interposed in fluid communication between the fluid line 76A, the fluid line 76B, and the fluid line 76C. The pressure regulator valve 88 cooperates with the switching valve 78 so as to direct fluid power from the outlet regions 42 of the pump 28 so as to accommodate the pressure and flow requirements of the circuits 68, 70, 72, 74 and ensure proper operation under different operating conditions of the step-gear automatic transmission 14. The pressure regulator valve 88 regulates the line pressure of the fluid line 76A in responding to instantaneous clutch actuation demand. It should be appreciated that regulating and maintaining the correct line pressure by the pressure regulator valve 88 ensures the proper operation of the powertrain system 10.

Specifically, the pressure regulator valve 88 shown in FIG. 2 has a first pressure regulator position, a second pressure regulator position, a third pressure regulator position, and a fourth pressure regulator position. When the pressure regulator valve 88 is in the first pressure regulator position, when the engine is at low speed, such as idle, the flow is limited. The pressure regulator valve 88 is fully closed so that all the flow from the pump 28 is used to create the pressure needed and only flow to the clutch actuation circuit 68. When the pressure regulator valve 88 is in the second pressure regulator position, while engine speed increases, the pump flow increases proportionally due to the fixed ratio between the pump 28 and the prime mover 36. At such position, a port opens and partial flow will be directed to the solenoid controls circuit 70 and the torque converter circuit 72. When the pressure regulator valve 88 is in the third pressure position, another port opens and partial flow will be directed to the solenoid controls circuit 70, the torque converter circuit 72, and gearbox cooling and lubrication circuit 74. When the pressure regulator valve 88 is in the fourth pressure regulator position, at even higher engine speed, after satisfying the line pressure demand and lubrication/cooling demand, any more excess flow is routed back to the pump inlet region 40 through the suction return fluid circuit to prevent higher drag torque caused by high fluid flow in the clutch and other components. The pressure regulator valve 88 is selectively movable between the regulator positions so as to cooperate with the switching valve 78 as noted above. Those having ordinary skill in the art will appreciate that the positions of the pressure regulator valve 88 may correlate with the positions of the switching valve 78 or may be selected independent and irrespective of the positions of the switching valve 78. As is described in greater detail below, the pressure regulator valve 88 and switching valve 78 can be controlled, configured, oriented, or disposed in a number of different ways. It should be appreciated that the pressure regulator valve 88 is a proportional valve and has infinite positions when it is continuously regulating even though there are only three positions described. It should also be appreciated that the pressure regulator valve 88 could be omitted from the multi-pressure hydraulic control system 66 or modified to have a different number of positions and different movement through these positions without departing from the scope of the present invention.

As noted above, the multi-pressure hydraulic control system 66 may include a controller 24 in electrical communication with one or more solenoid valves 26 used to control the switching valve 78. In one embodiment, the switching valve 78 is further defined with a spring-biased valve member 79 having a hydraulic switch inlet (not shown). The controller 24, via the solenoid valve 26, controls the switching valve 78, whereby the solenoid valve 26 is interposed in fluid communication between the fluid line 76A and the hydraulic switch inlet. It should be appreciated that the switching valve 78 could be of any suitable type, controlled in any suitable way, without departing from the scope of the present invention.

The controller 24, sometimes referred to in the related art as an “electronic control module,” may also be used to control other components of the step-gear automatic transmission 14. Further, in one embodiment, the multi-pressure hydraulic control system 66 includes at least one sensor 96 disposed in fluid communication with the fluid line 76A and disposed in electrical communication with the controller 24 (electrical connection not shown in detail, but generally known in the art). The sensor 96 generates a signal representing at least one of hydraulic pressure, temperature, viscosity, and/or flowrate. The controller 24 may be configured to monitor the sensor 96 to move the switching valve 78 between the positions. In one embodiment, the sensor 96 is a pressure transducer for generating a signal representing the hydraulic fluid pressure occurring at the fluid line 76A. While a single sensor 96 is utilized in the representative embodiment illustrated herein, it should be appreciated that the multi-pressure hydraulic control system 66 could include any suitable number of sensors, of any suitable type, arranged in any suitable way, without departing from the scope of the present invention.

In addition, the present invention provides a method for controlling the multi-pressure hydraulic control system 66 for use with the step-gear automatic transmission 14 of the vehicle powertrain system 10. The method includes the steps of pumping fluid by at least one pump 28 including a rotatable pump member 34, at least one inlet region 40 for receiving fluid to be pumped by the pump member 34, and at least one outlet region 42 for outputting fluid pumped by the pump member 34. The method also includes the steps of receiving at a switching valve 78 at least three outputs of fluid pumped by the at least one pump 28, the switching valve 78 having a valve member 79 being movable between at least three positions, and moving the valve member 79 between the at least three positions to produce fluid outputs having a high fluid pressure, a medium fluid pressure, and a low fluid pressure to one or more portions of the step-gear automatic transmission 14. It should be appreciated that the method includes other steps corresponding to the functions described above for the multi-pressure hydraulic control system 66.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

1. A multi-pressure hydraulic control system (66) for use with a step-gear automatic transmission (14) of a vehicle powertrain system (10), said hydraulic control system comprising:
at least one pump (28) including a rotatable pump member (34), at least one inlet region (40) for receiving fluid to be pumped by said pump member (34), and at least one outlet region (42) for outputting fluid pumped by said pump member;
a switching valve (78) receiving at least three separate outputs of fluid pumped by said at least one pump (28) for allowing the at least three separate outputs to be selectively combined and/or separated, said switching valve (78) having a valve member (79) being movable between at least three positions that produces fluid outputs having a high fluid pressure, a medium fluid pressure, and a low fluid pressure to one or more portions of the step-gear automatic transmission (14).

2. A multi-pressure hydraulic control system (66) as set forth in claim 1 including a pressure regulator (88) fluidly communicating with at least one of said at least two separate outputs of fluid pumped by said at least one pump (28) and with at least two of the fluid outputs having the at least two of the high fluid pressure, the medium fluid pressure, and the low fluid pressure to regulate the pressure of the fluid to the one or more portions of the step-gear automatic transmission (14).

3. A multi-pressure hydraulic control system (66) as set forth in claim 1 wherein one of said at least three fluid outputs having the high fluid pressure fluidly communicates with at least one of a clutch portion (68) of the step-gear automatic transmission (14).

4. A multi-pressure hydraulic control system (66) as set forth in claim 1 wherein one of said at least three fluid outputs having the medium fluid pressure fluidly communicates with at least one of a torque converter portion (72) and solenoid controls portion (70) of the step-gear automatic transmission (14).

5. A multi-pressure hydraulic control system (66) as set forth in claim 1 wherein one of said at least three fluid outputs having the low fluid pressure fluidly communicates with at least one of a gearbox portion (74) of the step-gear automatic transmission (14).

6. A multi-pressure hydraulic control system (66) as set forth in claim 2 wherein said pressure regulator (88) is fluidly connected to said at least two fluid outputs having the high fluid pressure, the medium fluid pressure, and the low fluid pressure.

7. A multi-pressure hydraulic control system (66) as set forth in claim 1 wherein said at least one pump (28) comprises a stator (30) having a chamber and said pump member (34) being disposed in said chamber and cooperating with said stator (30) so as to define at least three pumping regions in said chamber with each of said at least three pumping regions having said at least one inlet region (40) and said at least one outlet region (42), wherein rotation of said pump member (34) displaces fluid across each of said at least three pumping regions such that each said at least one outlet region (42) provides a separate source of fluid power to said switching valve (78).

8. A method for controlling a multi-pressure hydraulic control system (66) for use with a step-gear automatic transmission (14) of a vehicle powertrain system (10), said method comprising the steps of:
pumping fluid by at least one pump (28) including a rotatable pump member (34), at least one inlet region (40) for receiving fluid to be pumped by the pump member (34), and at least one outlet region (42) for outputting fluid pumped by the pump member (34); and
receiving at a switching valve (78) at least three outputs of fluid pumped by the at least one pump (28), the switching valve (78) having a valve member (79) being movable between at least three positions, and moving the valve member (79) between the at least three positions to produce fluid outputs having a high fluid pressure, a medium fluid pressure, and a low fluid pressure to one or more portions of the step-gear automatic transmission (14).

9. A method as set forth in claim 8 including the step of providing a pressure regulator (88) and fluidly communicating the pressure regulator (88) with at least one of the three separate outputs of fluid pumped by the at least one pump (28) and with at least two of the at least three fluid outputs of the switching valve (78) to regulate the pressure of the fluid to the one or more portions of the step-gear automatic transmission (14).

10. A method as set forth in claim 8 including the step of fluidly communicating one of the at least three fluid outputs having the high fluid pressure with a clutch portion (68) of the step-gear automatic transmission (14).

11. A method as set forth in claim 8 including the step of fluidly communicating one of the at least three fluid outputs having the medium fluid pressure with at least one of a torque converter portion (72) and solenoid controls portion (70) of the step-gear automatic transmission (14).

12. A method as set forth in claim 8 including the step of fluidly communicating one of the at least three fluid outputs having the low fluid pressure with at least one of a gearbox portion (74) of the step-gear automatic transmission (14).

13. A method as set forth in claim 9 including the step of fluidly connecting the pressure regulator (88) to the at least two of the at least three fluid outputs having the high fluid pressure, the medium fluid pressure, and the low fluid pressure.

14. A method as set forth in claim 8 including the step of providing the at least one pump (28) with a stator (30) having a chamber and the pump member (34) being disposed in the chamber and cooperating with the stator (30) so as to define at least three pumping regions in the chamber with each of the at least three pumping regions having the at least one inlet region (40) and the at least one outlet region (42), wherein rotation of the pump member (34) displaces fluid across each of the at least three pumping regions such that each of the at least one outlet region (42) provides a separate source of fluid power to the switching valve (78).
